(19) United States
(12) Patent Application Publication
(10) Pub. No.: US 2016/0222815 A1
(43) Pub. Date: Aug. 4, 2016

(54) High Efficiency Geared Turbofan

(71) Applicant: UNITED TECHNOLOGIES CORPORATION, Hartford, CT (US)

(72) Inventors: Frederick M. Schwarz, Glastonbury, CT (US); Shankar S. Magge, South Windsor, CT (US)

(21) Appl. No.: 15/021,046

(22) PCT Filed: Mar. 5, 2014
(86) PCT No.: PCT/US14/20483

§ 371 Date: Mar. 10, 2016

Related U.S. Application Data
(60) Provisional application No. 61/885,145, filed on Oct. 1, 2013.

(51) Int. Cl. F01D 15/12; F01D 5/06; F01D 5/18; F02K 3/04

(52) U.S. Cl. CPC F01D 15/12; F02K 3/04; F01D 5/06; F01D 5/18; F05D 2220/36; F05D 2240/60

(57) ABSTRACT

A gas turbine engine comprises a fan drive turbine. The fan drive turbine drives the fan through a gear reduction; A change in enthalpy is defined across the gas turbine engine. The change in enthalpy divided by a speed of the fan drive turbine squared is less than or equal to about 1.8. An axial component of gases approaching an upstream most blade of the fan drive turbine divided by the speed of the fan drive turbine is equal to or less than about 0.9.

### RELATED APPLICATION

This application claims priority to provisional application 61/885145 filed on 1 Oct. 2013.

### BACKGROUND OF THE INVENTION

This application relates to a geared turbofan gas turbine engine wherein the turbine efficiency is increased compared to the prior art.

Gas turbine engines as known include a fan delivering air into a compressor section. The compressor compresses the air and delivers the air into a combustor section where it is mixed with fuel and ignited. Products of this combustion pass downstream over turbine rotors driving them to rotate.

Historically, in one type of gas turbine engine there were two turbine rotors and two compressor rotors. A lower pressure turbine rotor drove a lower pressure compressor rotor and also drove the fan rotor at a single rate of speed. In another type of gas turbine engine, there were three turbine rotors with the first two turbines driving two compressor sections and a turbine rotor driving the fan rotor directly with no, or minimal attached compressor stages.

More recently, it has been proposed to include a gear reduction between the low pressure compressor and the fan rotor.

This has provided improvements in the operation of a gas turbine engine.

### SUMMARY OF THE INVENTION

In a featured embodiment, a gas turbine engine comprises a fan drive turbine. The fan drive turbine drives the fan through a gear reduction; A change in enthalpy is defined across the gas turbine engine. The change in enthalpy divided by a speed of the fan drive turbine squared is less than or equal to about 1.8. An axial component of gases approaching an upstream most blade of the fan drive turbine divided by the speed of the fan drive turbine is equal to or less than about 0.9.

In another embodiment according to the previous embodiment, the fan drive turbine also drives ng a compressor rotor, and then drives the fan through the gear reduction such as the compressor rotor. The fan drive turbine rotates at a higher speed than the fan.

In another embodiment according to any of the previous embodiments, a gear ratio of the gear reduction is greater than or equal to 2.6.

In another embodiment according to any of the previous embodiments, the fan drive turbine has three to six stages.

In another embodiment according to any of the previous embodiments, the fan drive turbine is at least partially manufactured from a directionally solidified material.

In another embodiment according to any of the previous embodiments, the fan drive turbine includes at least one cooled blade.

In another embodiment according to any of the previous embodiments, the gear ratio is greater than or equal to 3.0.

In another embodiment according to any of the previous embodiments, the speed of the fan drive turbine is a mean line velocity measured in feet per second. The change in enthalpy is measured in joules. The axial component of the gases is measured in feet per second.

In another embodiment according to any of the previous embodiments, the fan drive turbine is utilized in combination with at least two additional turbine rotors where each drive a compressor rotor.

In another embodiment according to any of the previous embodiments, a gear ratio of the gear reduction is greater than or equal to 2.6.

In another embodiment according to any of the previous embodiments, the gear ratio is greater than or equal to 3.0.

In another embodiment according to any of the previous embodiments, the fan drive turbine has three to six stages.

In another embodiment according to any of the previous embodiments, the fan drive turbine is at least partially manufactured from a directionally solidified material.

In another embodiment according to any of the previous embodiments, at least one of the two additional turbine rotors is made at least in part from a single crystal material.

In another embodiment according to any of the previous embodiments, the fan drive turbine includes at least one cooled blade.

In another embodiment according to any of the previous embodiments, the speed of the fan drive turbine is a mean line velocity measured in feet per second. The change in enthalpy is measured in joules. The axial component of the gases is measured in feet per second.

In another embodiment according to any of the previous embodiments, a gear ratio of the gear reduction is greater than or equal to 2.6.

In another embodiment according to any of the previous embodiments, the gear ratio is greater than or equal to 3.0.

In another embodiment according to any of the previous embodiments, the fan drive turbine has three to six stages.

In another embodiment according to any of the previous embodiments, the fan drive turbine is at least partially manufactured from a directionally solidified material.

In another embodiment according to any of the previous embodiments, the fan drive turbine includes ng at least one cooled blade.

These and other features may be best understood from the following drawings and specification.

### BRIEF DESCRIPTION OF THE DRAWINGS

FIG. 1 schematically shows a gas turbine engine.

FIG. 2 shows the boundaries for a high efficiency engine such as illustrated in FIG. 1.

FIG. 3 is a graph of work coefficient versus flow coefficient.

FIG. 4A shows a low efficiency turbine rotor.

FIG. 4B shows a higher efficiency turbine rotor.

FIG. 5 shows another embodiment.

FIG. 6 shows another embodiment.

FIG. 7 shows exemplary values for a plurality of quantities.

### DETAILED DESCRIPTION

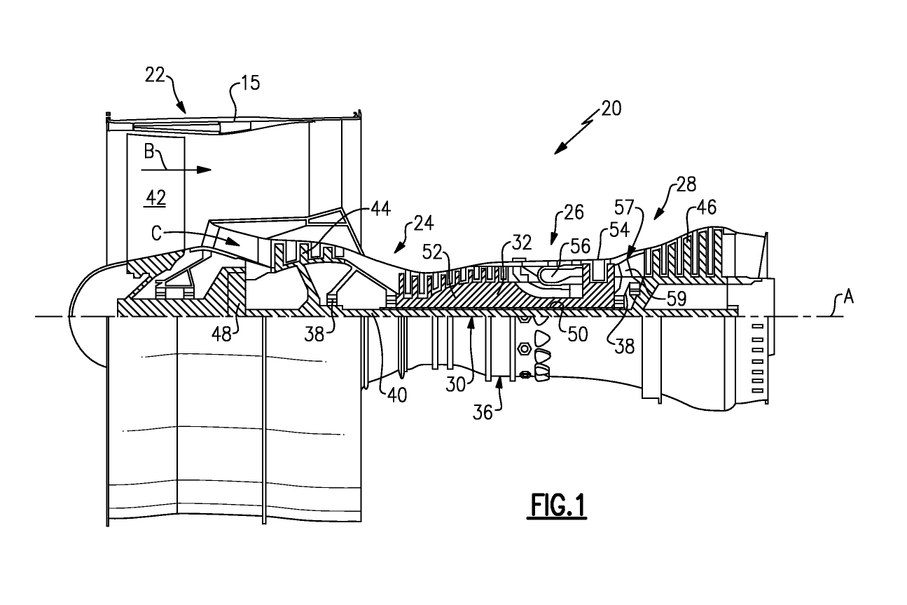

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures. In another embodiment there are at least three turbines. Further, in another embodiment, there are at least two turbines in front of a fan drive turbine to reduce gas temperature entering the fan drive turbine. In another embodiment , the at least two turbines rotate independently.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. In another embodiment, the bypass ratio is greater than 12.0. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than or equal to about 2.6. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine thrust set at its best fuel consumption—also known as “bucket cruise Thrust Specific Fuel Consumption ('TSFC')”—is the industry standard parameter of lbm of fuel burned per hour being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7 ° R)]^{0.5}. The “Low corrected fan tip speed” as disclosed herein according to one non-limiting embodiment is less than about 1150 ft/second.

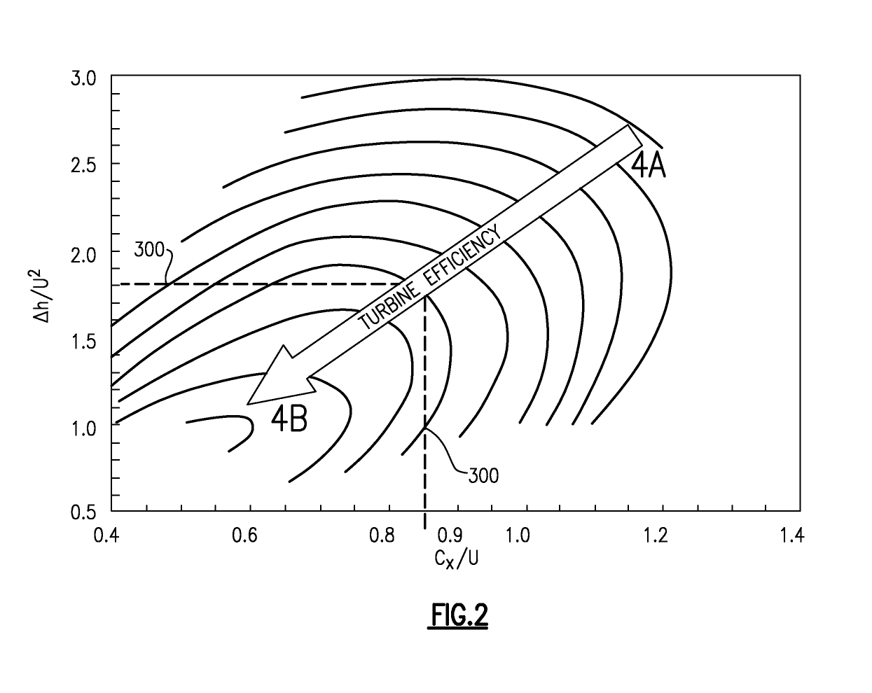

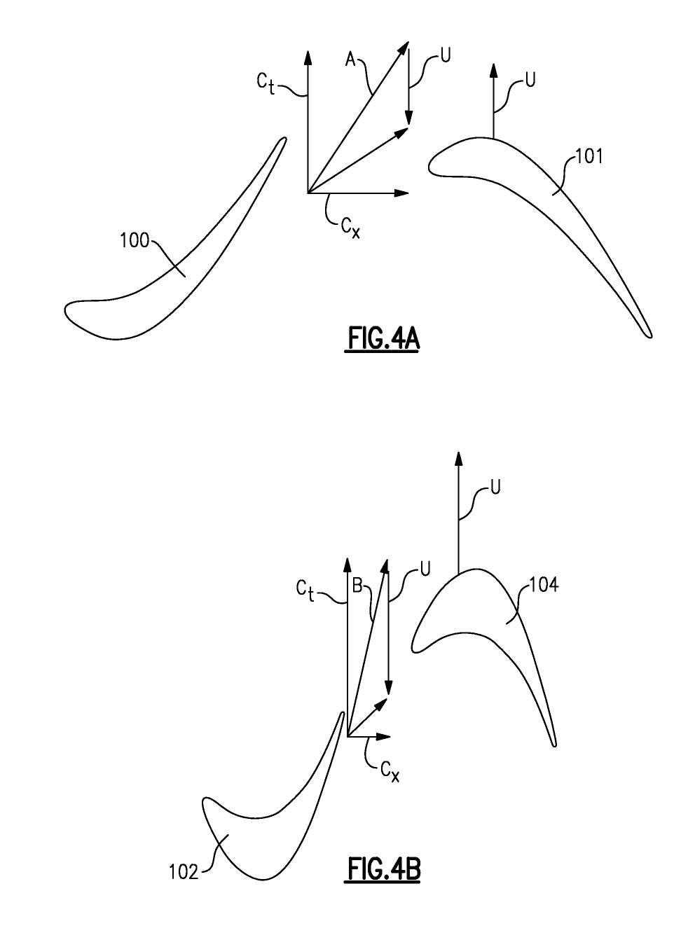

FIG. 2 is a graph of the quantities Δh/U² versus Cₓ/U. As shown, turbine efficiency increases as one heads toward zero for both quantities. A low efficiency island is shown near the upper right corner of the graph and includes a turbine designed as shown in FIG. 4A. The higher efficiency island is shown near the bottom left corner and would include turbine blades designed closer to that shown in FIG. 4B.

As shown, by increasing U which is the speed of a fan drive turbine 46 driving the fan rotor 24, turbine efficiency tends to be raised.

The turbine efficiency plot shown here includes the Ah which is a total enthalpy change. Enthalpy is a measure of the total energy of a thermodynamic system. It includes the system's internal energy or thermodynamic potential as well as its volume and pressure. The unit of measurement for enthalpy in the international system of units is the joule, but other historical conventional units are still in use, such as the British Thermal Unit and the calorie.

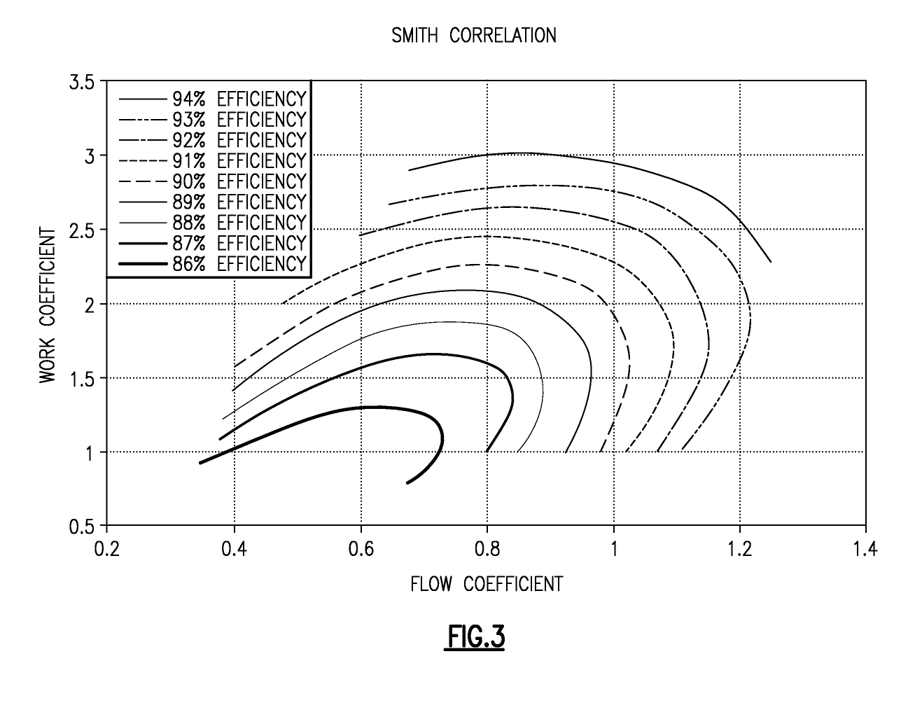

A work coefficient quantity is Δh/U² and is a parameter in which the dimensions are read out, such that it is dimension-less, and relates the turbine work to the mean wheel speed of the turbine U. The use of this work coefficient combined with a flow coefficient Cₓ/U, shown in FIG. 3. The flow coefficient Cₓ/U is a good indicator of a velocity triangle in a fan drive turbine. A low Cₓ/U design can be characterized by high turning speed within an individual blade row and relatively low axial velocity. On the other hand, high Cₓ/U designs tend toward low turning in the blade row and low camber airfoils.

As an example, FIG. 4A shows the nature of the low efficiency islands in FIG. 2 (as shown by the general location 4A in FIG. 2) wherein the gas vector “A” coming off a stator 100 is poorly aligned to the tangential Cₜ and U directions as it approaches a rotor blade 101. This inherently makes the gases approaching the rotor blade 101 more axial, which is undesirable and less tangential which is desirable.

On the other hand, FIG. 4B shows a high efficiency island, shown generally as 4B in FIG. 2. Here, the stator 102 is designed in combination with a rotor 104 such that the gas coming off of the stator is closer to the tangential Cₜ and U directions. This inherently improves the presentation of velocity energy to the rotating blade 104. That is, the U component is greater than in FIG. 4A. Further, the great increase in U raises the stress in all areas of the fan drive turbine. If high efficiency and high U are desired, this may necessitate the use of materials with higher strength at a given temperature. The designer may also cool the turbine to increase the allowable stress with a weaker class of material.

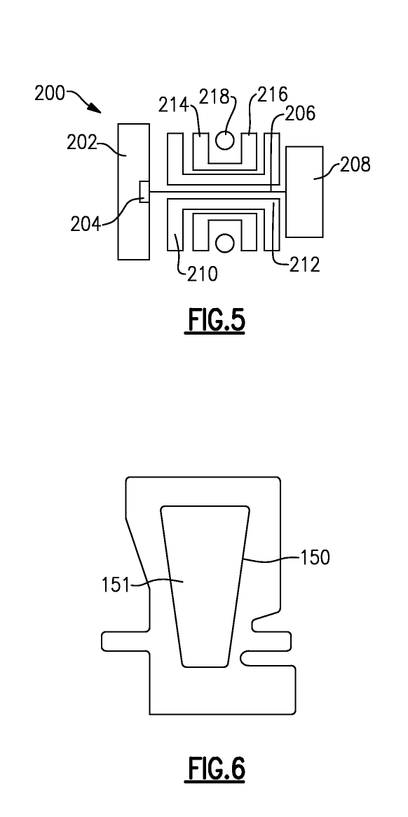

FIG. 5 shows an embodiment 200, wherein there is a fan drive turbine 208 driving a shaft 206 to in turn drive a fan rotor 202. A gear reduction 204 may be positioned between the fan drive turbine 208 and the fan rotor 202. A compressor rotor 210 is driven by an intermediate pressure turbine 212, and a second stage compressor rotor 214 is driven by a turbine rotor 216. A combustion section 218 is positioned intermediate the compressor rotor 214 and the turbine rotor 216. This engine may operate as discussed with regard to FIGS. 2, 3, 4B and 7, as may the engine 20 of FIG. 1.

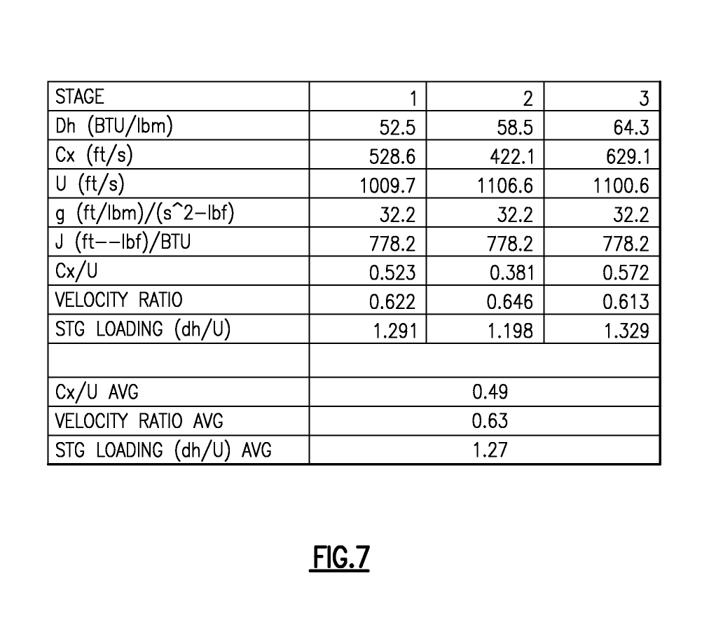

In addition, a directionally solidified material may be utilized for the fan drive turbine 46 or even a more temperature capable material such as a single crystal material or an internally cooled blade. Such materials may be used for at least one blade in the particular turbine. As shown in FIG. 6, a turbine blade 150 for use in the engine of FIG. 1 or 5, can have internal cooling passages 151, as known.

Gear ratios equal to or above 2.6 for the gear reduction 48 may be utilized. In embodiments, the gear ratio may be equal to or above 3.0.

The fan rotor 42 may be sized to maximize the bypass ratio while minimizing fuel burn.

FIG. 7 shows a sample of turbine engines and a number of quantities.

The fan drive turbine in these example engines may have three to five low pressure turbine stages.

In the above referenced system, the Cₓ/U quantity averages out to 0.49. Cₓ is an average axial velocity taken in feet/second and U is the rotor speed at a mean line velocity in feet per second. The stage loading quantity dh/U² average equals 1.27. Both of the flow coefficient and work coefficient quantities are non-dimensional. What is referred to here as dh/U² is really gJdh/U² where g equals 32.2 feet pounds per minute/second squared per lbf and J equals 778-feet lbf/btu. dh equals a change in specific enthalpy across the turbine measured in btu/lbm and U equals a rotor speed at a mean radius in feet per second.

As can be appreciated from FIG. 2 and by the boundary 300, Applicant has designed gas turbine engines wherein a fan drive turbine drives a fan through a gear reduction, wherein a change in enthalpy divided by a speed of the fan drive turbine squared is less than or equal to about 1.8. In addition, an axial component of the gas approaching the upstream most blade of the fan drive turbine divided by the speed of the fan drive turbine is equal to or less than about 0.9.

Although an embodiment of this invention has been disclosed, a worker of ordinary skill in this art would recognize that certain modifications would come within the scope of this invention. For that reason, the following claims should be studied to determine the true scope and content of this invention.

1. A gas turbine engine comprising:
a fan drive turbine;
a fan, said fan drive turbine for driving said fan through a gear reduction;
wherein a change in enthalpy is defined across said gas turbine engine, and said change in enthalpy divided by a speed of the fan drive turbine squared is less than or equal to about 1.8; and
an axial component of gases approaching an upstream most blade of the fan drive turbine divided by said speed of the fan drive turbine is equal to or less than about 0.9.

2. The gas turbine engine as set forth in claim 1, wherein said fan drive turbine also driving a compressor rotor, and then for driving said fan through said gear reduction such that the compressor rotor and said fan drive turbine rotate at a higher speed than said fan.

3. The gas turbine engine as set forth in claim 2, wherein a gear ratio of said gear reduction being greater than or equal to 2.6.

4. The gas turbine engine as set forth in claim 3, wherein said fan drive turbine having three to six stages.

5. The gas turbine engine as set forth in claim 3, wherein said fan drive turbine is at least partially manufactured from a directionally solidified material.

6. The gas turbine engine as set forth in claim 3, wherein said fan drive turbine including at least one cooled blade.

7. The gas turbine engine as set forth in claim 3, wherein said gear ratio is greater than or equal to 3.0.

8. The gas turbine engine as set forth in claim 2, wherein said speed of said fan drive turbine is a mean line velocity measured in feet per second, the change in enthalpy is measured in joules, the axial component of the gases is measured in feet per second.

9. The gas turbine engine as set forth in claim 1, wherein said fan drive turbine is utilized in combination with at least two additional turbine rotors where each of said at least two additional turbine rotors driving a compressor rotor.

10. The gas turbine engine as set forth in claim 9, wherein a gear ratio of said gear reduction being greater than or equal to 2.6.

11. The gas turbine engine as set forth in claim 10, wherein said gear ratio is greater than or equal to 3.0.

12. The gas turbine engine as set forth in claim 10, wherein said fan drive turbine having three to six stages.

13. The gas turbine engine as set forth in claim 10, wherein said fan drive turbine is at least partially manufactured from a directionally solidified material.

14. The gas turbine engine as set forth in claim 9, wherein at least one of said two additional turbine rotors is made at least in part from a single crystal material.

15. The gas turbine engine as set forth in claim 9, wherein said fan drive turbine including at least one cooled blade.

16. The gas turbine engine as set forth in claim 9, wherein said speed of said fan drive turbine is a mean line velocity measured in feet per second, the change in enthalpy is measured in joules, the axial component of the gases is measured in feet per second.

17. The gas turbine engine as set forth in claim 1, wherein a gear ratio of said gear reduction being greater than or equal to 2.6.

18. The gas turbine engine as set forth in claim 17, wherein said gear ratio is greater than or equal to 3.0.

19. The gas turbine engine as set forth in claim 1, wherein said fan drive turbine having three to six stages.

20. The gas turbine engine as set forth in claim 1, wherein said fan drive turbine is at least partially manufactured from a directionally solidified material.

21. The gas turbine engine as set forth in claim 1, wherein said fan drive turbine including at least one cooled blade.
